(19) United States
(12) Patent Application Publication
(10) Pub. No.: US 2016/0055857 A1
(43) Pub. Date: Feb. 25, 2016

(54) SYSTEM AND METHOD FOR GENERATING DYNAMIC SOUND ENVIRONMENTS

(71) Applicant: Matthew Lee Johnston, Seattle, WA (US)

(72) Inventor: Matthew Lee Johnston, Seattle, WA (US)

(21) Appl. No.: 14/463,643

(22) Filed: Aug. 19, 2014

(51) Int. Cl. G10L 19/00

(52) U.S. Cl. CPC G10L 19/0017

(57) ABSTRACT

A method comprising receiving a message request, obtaining a set of geographic coordinates from the received message request, conducting a first search of one or more meta-element databases using the set of geographic coordinates to obtain a plurality of metatags associated with the set of geographic coordinates, conducting a second search of one or more audio content databases using the plurality of metatags to obtain a plurality of audio sound files, generating a sound-stream using the plurality of audio sound files, the audio sound files comprising stored representations of simulated audio content and synthetic audio content associated with the set of geographic coordinates, encoding the sound-stream for rendering on a client device using one or more device-specific parameters in the message request, and transmitting the encoded sound-stream to the client device.

### FIELD

The present disclosure relates generally to the field of computer data processing, and in particular but not exclusively, relates to a system and method for generating dynamic sound environments using user-specified temporal and geo-location information.

### BACKGROUND

The rapid pace of progress in computing and communications has produced a plethora of applications that can be used to analyze, process or evaluate a wide range of resources both online and offline. One by-product of the advancement in computing and communications capabilities is the unparalleled ability to assess and review video, speech, image and textual data from resources around the world with breathtaking speed, accuracy and precision. Indeed, omnipresent networks of satellites have now enabled the average consumer to gain access to satellite imagery of nearly every part of the world, all of which is accessible on a consumer desktop, laptop or any of a number portable, handheld devices.

Despite the significant abilities of current computing systems to access imagery of nearly every corner of the world from satellites and other resources, there are no audio equivalents for satellite imagery of the planet. Indeed, while nearly every corner of the earth can be viewed using resources such as Google Maps, it is not presently possible to know the sound environment of any given location on the planet.

An understanding of the natural sound environment of any location on the planet is not only aesthetically appealing, but may also be physiologically important. The World Health Organization has identified noise pollution as a global health crisis. As one example, overhead air traffic alone has reduced the number of places where one can listen to nature to a very small number of remote and hard to reach places. An inability to listen to any place on the planet, without human interference, whenever one wants on any device could potentially prevent humans from truly understanding the aural properties of the planet and further exacerbate the problems associated with noise pollution.

Aside from the aesthetic aspects of accessing natural sounds of any location on the planet on demand, there is also a potentially significant commercial dimension. Any restaurant, business, hotel or vacation rental can currently use photography to give potential customers an idea of the location where they are considering a visit, but it is not presently possible to provide such customers with an understanding of the ambient sound environment of the location on a website or on some other computer accessible resource.

The best available alternatives are compact discs and sound effects libraries with stored nature sounds, but such compact discs and libraries deliver the same sound content each time they are played or accessed and thus are limited and inflexible resources. It is not presently possible to generate dynamic and unique sound content for any given location on the planet. Lacking this ability to dynamically generate a unique sound environment for any location on the planet, many conventional systems simply increase fatigue in the listener due to the repetitive nature of the sound content and generally decrease the overall value of the sound experience. This phenomena is particularly acute as people struggle to regain control over their sonic space in their homes, cars and lives using static and “brute” force masking approaches involving the drowning out of noise with pre-recorded linear music and contemporary noise generators.

Thus, there is a significant and growing need for a system and related methods for dynamic generation of geo-location specific sound environments that can enable users to gain access to a “soundscape” for any chosen location on the planet in a manner similar to the current ability to access visual information using systems like Google Maps. Content stored on nature CDs and pre-recorded audio samples stored in effects libraries can be rendered with high audio quality, the sound content on such resources cannot be dynamically adjusted based on user location, time changes, or offer the sound of any location on the planet upon demand. Thus, there is also a pressing need for a solution that can preserve the recording quality of resources such as nature CDs and sound effects libraries with a capability to generate sound for any given location at any given time designated by a user using a dynamic, procedural approach so that the audio content produced is not only unique but consistently appealing and varied.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a diagram illustrating an operating environment for a dynamic sound generation system in an embodiment.

FIG. 2 is a block diagram illustrating the components of a client device used with a dynamic sound generation system in an embodiment.

FIG. 3 is a block diagram illustrating the components of an application server used in a dynamic sound generation system in an embodiment.

FIG. 4 is a block diagram illustrating the databases accessed from an application server used in a dynamic sound generation system in an embodiment.

FIG. 5 is a flowchart illustrating a method for generating dynamic sound environments in an embodiment.

FIG. 6 is a flowchart illustrating a method for dynamic sequencing of sound samples in an embodiment.

FIG. 7 is a flowchart illustrating a method for dynamic mixing of sound samples in an embodiment.

### DETAILED DESCRIPTION

In the description to follow, various aspects of embodiments will be described, and specific configurations will be set forth. These embodiments, however, may be practiced with only some or all aspects, and/or without some or all of these specific details. In other instances, well-known features are omitted or simplified in order not to obscure important aspects of the embodiments.

Various operations will be described as multiple discrete steps in turn, in a manner that is most helpful in understanding each disclosed embodiment; however, the order of description should not be construed as to imply that these operations are necessarily order dependent. In particular, these operations need not be performed in the order of presentation.

The description repeatedly uses the phrases “in one embodiment,” which ordinarily does not refer to the same embodiment, although it may. The terms “comprising,” “including,” “having,” and the like, as used in the present disclosure are synonymous.

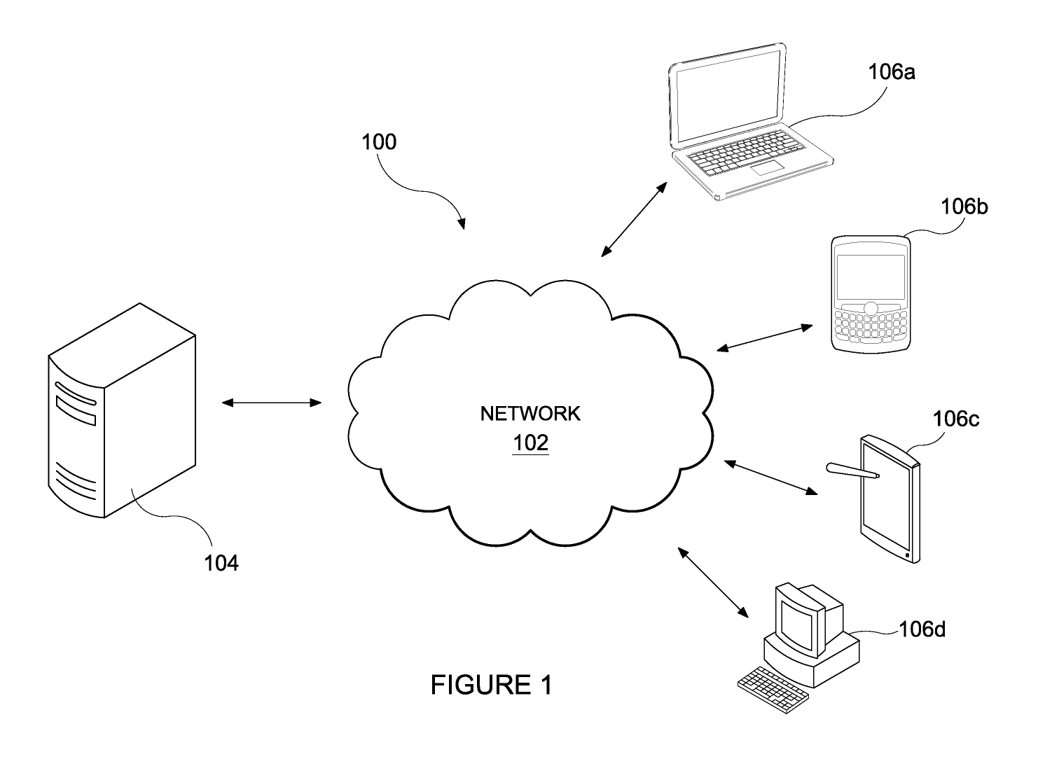

FIG. 1 is an illustration of an operating environment 100 for a dynamic sound generation system in an embodiment. The operating environment 100 for the system includes one or more client devices 106a, 106b, 106c, 106d which are communicatively coupled over a network 102 to an application server 104. The application server 104 is a computing device including one or more processors, a bus, a sound coder/decoder, one or more program memories, one or more secondary storage resources, and a network interface controller for receiving user requests and transmitting data streams for rendering of sound content, referred to as “sound-streams,” on the client devices 106a, 106b, 106c, 106d. In the present embodiment, various types of client devices can be used to render the sound-streams generated on the application server 104, including laptop computers 106a, smart phones 106b, personal digital assistants 106c, and desktop computers 106d. Each client device includes at least one or more processors, a bus, one or more program memories, one or more secondary storage resources, and a network interface controller. In the illustrated embodiment, the network 102 is the Internet. In alternative embodiments, the network 102 can be a private computer-communications network (e.g., an Intranet), a wireless communications network, or other computer data communications network that can enable communications between each type of client device and the operative components of a dynamic sound generation system executed on the application server 106. Although the present embodiment illustrates a system including one application server 104, it should be readily understood by those of ordinary skill in the art that one or more application servers can be used to execute the operative components of the dynamic sound generation system using distributed processing techniques, or that each operative component can execute one or more processes concurrently on a server that supports multithreaded processing of requests received from multiple client devices 106a, 106b, 106c, 106d.

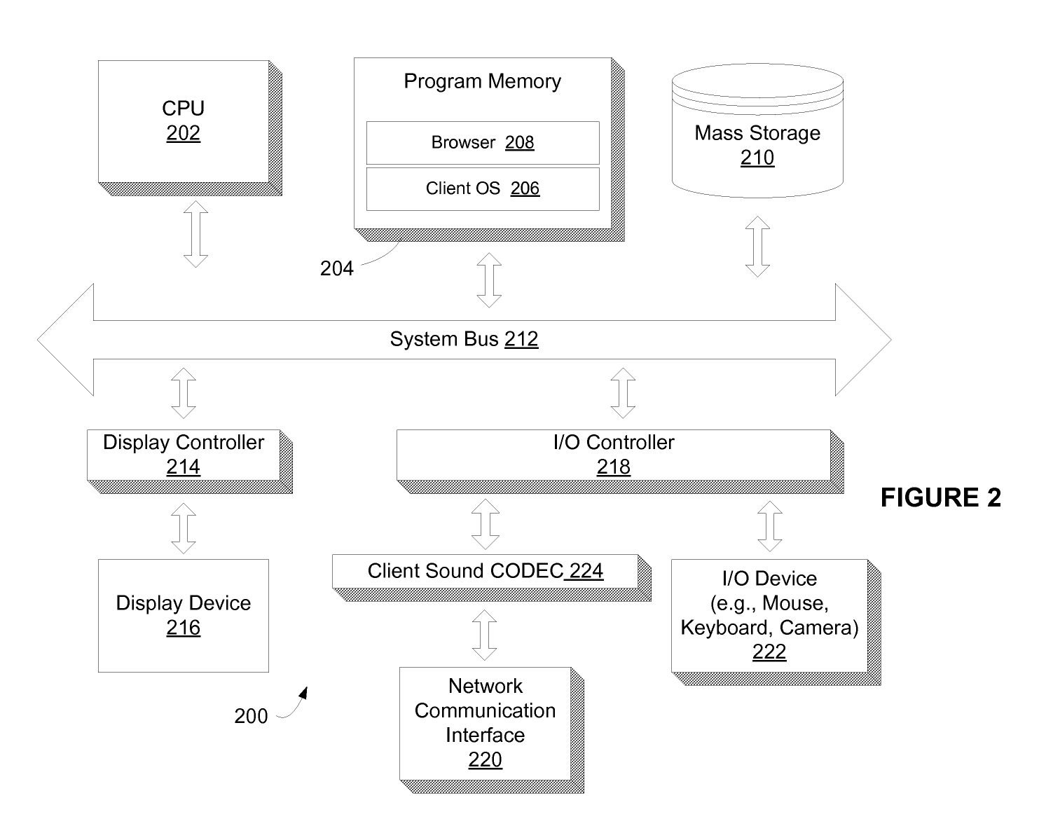

FIG. 2 is a block diagram illustrating the operative components of a client device 200 used in a dynamic sound generation system in an embodiment. In the illustrated embodiment, each client device 200 includes several interoperating components including a central processing unit (CPU) 202, a program memory 204, a mass storage resource 210 (e.g., external hard disks, etc.), a display controller 214 and an input/output controller 218. Each component of the client device is communicatively coupled to a system bus 212 for the passing of instructions to and from CPU 202 and data. In the present embodiment, the data transmitted between the operative components and processed by the CPU 202 includes user input received on an input/output device 222 and multi-packet messages comprising sound-streams received from an application server for streamed rendering on the display device 216. In one embodiment the input/output controller includes an embedded coder/decoder (i.e., a “codec”) for use in decoding each sound-stream received from the application server. In an alternative embodiment the codec is an independent operative element in a client device whose rate of output data transmission is controlled by the input/output controller 218 for uninterrupted, synchronous rendering on the display device 216 under control of the display controller 214. One of ordinary skill in the art will recognize that a client device may have one or more processors each with their own central processing units for use in performing the processing contemplated herein with each enumerated embodiment. Implementations of client devices having multiple processors enable the execution of multiple, concurrent processes for the generation and transmission of message requests for the production and streaming of sound-streams.

The program memory 204 is comprised of one or more static random access memories (e.g., SRAM, etc.) or one or more dynamic random access memories (e.g., DRAM, SDRAM, DDR SDRAM, etc.) that store instructions for executing a local client operating system (the “Client OS”) 206 and instructions for executing a web browser 208. The CPU 202 uses the display controller 214 to display a graphical user interface of an executing instance of the browser 208 on the display device 216. In the present embodiment, the browser 208 can be anyone of a number of contemporary web browsers such as the Mozilla Firefox® browser or the Internet Explorer® browser, as well as contemporary mobile web browsers such as the Safari® web browser.

The display controller 214 is communicatively coupled to the display device 216 such as a monitor or display on which a graphical user interface of the browser 208 is provided for use by end-users in placing requests for sound-streams. As used herein, the term “sound management user interface” means the graphical user interface provided in the browser 208 for managing user requests and rendering associated sound-streams. In one embodiment, the sound management user interface of the browser 208 is enabled to communicate with the Client OS 206 to control one or more input queues for receiving user input requests and for controlling the rendering sound-streams on a client device based on the received user input requests. The input/output controller 218 is communicatively coupled to the system bus 212, a sound coder-decoder (“Client Sound CODEC”) 224, and to one or more input/output devices 222. The Client Sound Codec 224 is communicatively coupled to a network interface communication interface 220 and is used in a preferred embodiment to decode sound-streams received from an application server for rendering on a user-designated output device among the set of input/output devices 222. In an embodiment, the Client Sound Codec 224 uses a method for low loss decompression and decoding of received sound-streams and a continuous detection process for monitoring and adapting the sound-stream to provide high quality sound rendering on the user-designated output device. In an alternative embodiment, the Client Sound Code applies a lossless audio decompression method for decoding received sound-steams along with the continuous monitoring and adapting of the sound-stream for high quality sound output. The input/output devices 222 are collectively provided for receiving user input specifying parameters for a sound-stream and for the streamed rendering of the sound-stream on designated output devices (e.g., speakers, headphones, etc.). The input devices can include a camera, a mouse, a wired keyboard, a wireless keyboard or a software-implemented keyboard displayed in the graphical user interface of the browser 208 in an embodiment. The output devices can include one or more wired speakers, wireless speakers, a wired headphone or a wireless headphone in an embodiment.

In one embodiment, the sound management user interface of the browser 208 provides one or more control icons to enable a user to select specific output devices that are to be used for the streamed rendering of a desired sound-stream. The sound management user interface controls and manages the sound rendering process on the client device initially through use of a authentication handshake with an application server. During the authentication process, a “service request” message is created from a user's input and then transmitted to the application server. In one embodiment, the user input in the service request message includes at least a set of geographic coordinates of the requesting user's device (i.e., longitude and latitude). In one embodiment, the set of geographic coordinates received in the user input are translated into Geographic Coordinate System coordinates based on the longitude and latitude of the client device. The user input can also include current or desired time (past or future), current or desired date (past or future), current or desired weather, current or desired topographical features, and current, past or projected population. In response to the service request message, the application server will return a sound-stream comprised of one or more sound files which are transmitted as multi-packet messages. The sound management user interface will monitor and manage the buffering of received multi-packet messages into one or more input queues in the program memory 204 of the client device, process the received multi-packet messages and control the rendering of a complete sound-stream on one or more of the output devices 222 available on the client device using the input/output controller 212.

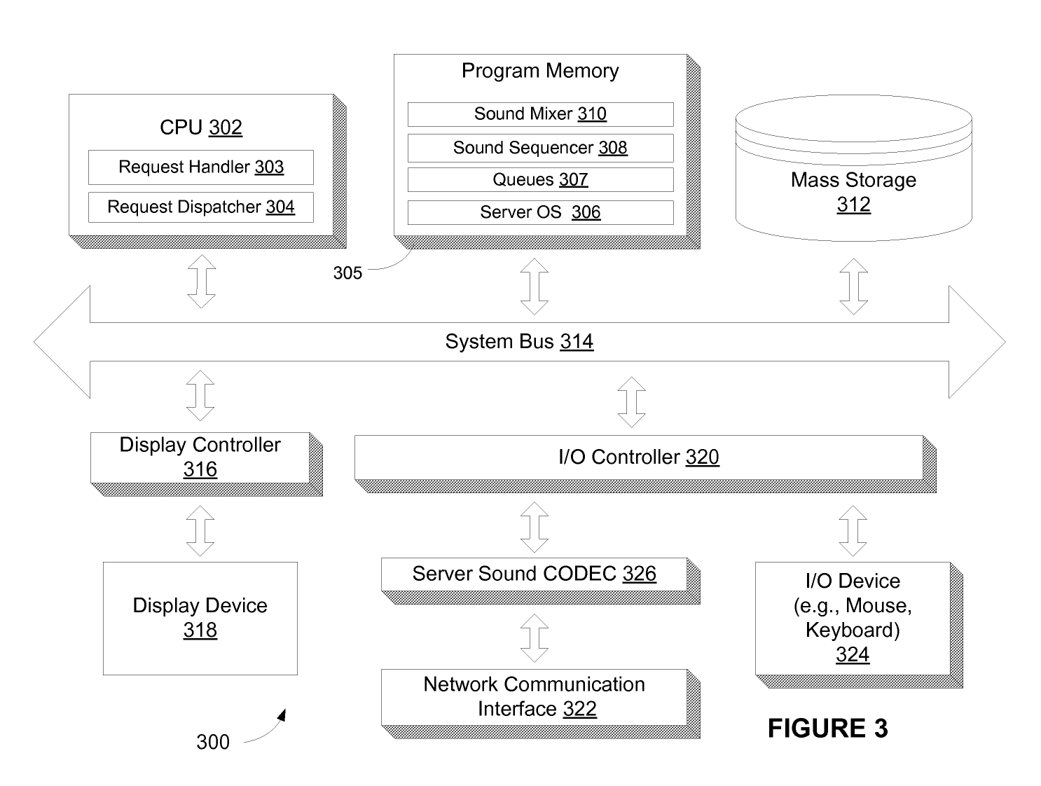

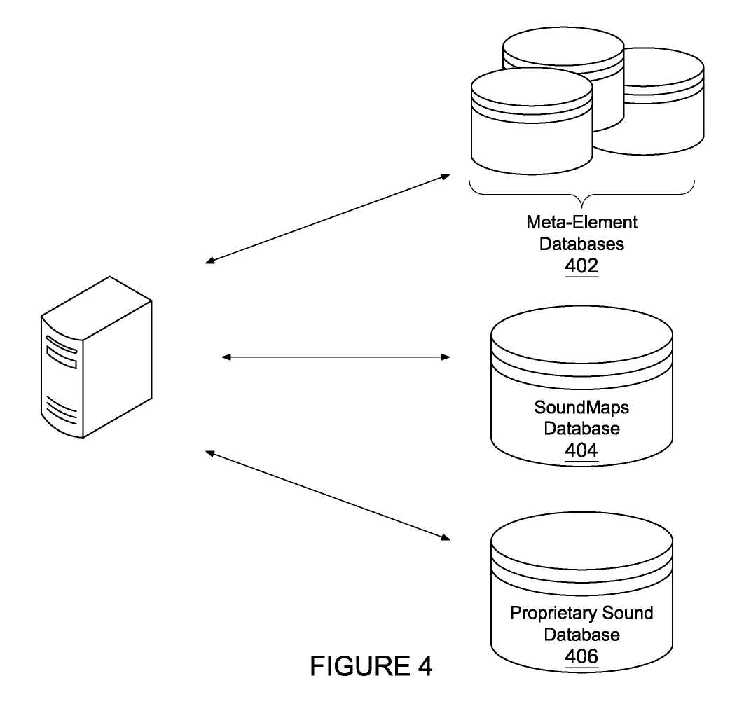

FIG. 3 is a block diagram illustrating the operative components of an application server 300 used in a dynamic sound generation system in an embodiment. The illustrated embodiment includes a central processing unit (CPU) 302, a program memory 305, a mass storage resource 312 (e.g., external hard disks, etc.), a system bus 314, a display controller 316 and an input/output controller 320. The display controller 316 and the input/output controller 320 are communicatively coupled to the system bus 314. The CPU 302, the program memory 304 and the mass storage device 312 are also communicatively coupled to the system bus 314 which is used for passing control instructions and data between active software-implemented components of the dynamic sound generation system and the passing of process control messages between active processes executed using the software-implemented components of the dynamic sound generation system. The program memory 305 includes a server operating system 306 (i.e., the “Server OS”), a plurality of active message queues 307, a sound sequencer 308, and a sound mixer 310. The CPU 302 executes two dynamic processes, a request handler 303 and a request dispatcher 304 each of which interoperate with the processes resident in the program memory 305. The request handler 303 and the request dispatcher 304 are extensions of the Server OS 306 that remain active for the duration of the execution of the dynamic sound generation system. The request handler in particular monitors a plurality input queues among the group of message queues 307 to identify new service requests. As each service request is identified, the request handler 303 invokes the request dispatcher 304 which then retrieves the service request, extracts the geographic location information (i.e., the GIS latitude and longitude information), initiates an active instance of the sound sequencer 308 and passes the geographic information to the active instance of the sound sequencer 308. After receipt of the geographic location information, the sound sequencer 308 executes a search of a one or more meta-element databases to identify the tags or other meta information that have been associated with the geographic location. If a set of tags are identified for the geographic location, these tags are extracted and incorporated into a secondary search request for use in searching one or more sound databases. The sound databases include compilations of sound files that are associated with groupings of tags. In one embodiment, these sound files are stored digitized sound content representing the ambient sound environment for a designated geographic location. The sound files matching the tags in the search request are retrieved from the sound databases, assembled into a sound sequence using the sound sequencer 308, and used in the sound mixer 310 to produce a sound-stream for streamed rendering to a client device. In one embodiment, one or more meta-element databases and the sound databases are stored on the mass storage resource 312. In an alternative embodiment, as represented in FIG. 4, one or more of the meta-element databases and one or more of the sound databases are stored in external storage resources such as cloud-based storage servers. As will be understood by those of ordinary skill in the art, one or more processors may be implemented on a server device, each with its own central processing unit, for the execution of multiple, concurrent processes, such as multiple instances of the request handler 303 and the request dispatcher 304. Multi-threaded processing systems as well as systems implementing multiple processors are contemplated within the scope of the present disclosure for use in responding to received service requests and in generating sound-streams related to such service requests.

In addition to the CPU 302 and the program memory 305, the server includes a display controller 316 that is communicatively coupled to a display device 318 on which, in one embodiment, the operational status of the request handler 303 and the request dispatcher 304 is displayed. An input/output controller 320 is also provided that is communicatively coupled to one or more input/output devices 324. In particular, the input/output controller 320 is communicatively coupled to the system bus 314, a sound coder/decoder 326 (the “Server Sound CODEC”) and one or more input/output devices 324, such as a mouse or keyboard. The Server Sound Codec 326 is communicatively coupled to the input/output controller 320 and a network communication interface 322. The network communication interface 322 receives encoded service requests from client devices for decoding by the Server Sound Codec 326 that are subsequently passed to an available message queue 307 of the dynamic sound generation system. The network communication interface 322 receives service requests in real-time as the location of the user's client device changes geographic location or as an end-user updates or adjusts the variable inputs for specific sound-streams (e.g., changes in weather, date, population and/or topographical features). The sound mixer 310 sends a control message to the input/output controller 320 to initiate the transmission of sound-streams from output queues 307 in the program memory 305. In one embodiment, a combination of bits used as a semaphore flag is set in a data packet of a multi-packet message comprising a sound-stream that enables the input/output controller 320 to identify which sound-streams are to be retrieved from the output queues 307 and sent to the Server Sound Codec 326 for encoding and transmission to a client device using the network communication interface 322. In this embodiment, the sound mixer 310 sets the semaphore flag in the data packet of the sound-stream to be transmitted. The data packet storing the semaphore flag is a header packet in the multi-packet message comprising the sound-stream in one embodiment. In an alternative embodiment, the Server OS 306 sets the semaphore flag in the data packet of the sound-stream after receipt of a “sound-stream ready” control message from the sound mixer 310. In one embodiment, the Server Sound Codec 326 applies a low loss process for the decoding and decompression of each received service request message and a low loss process for the encoding and compression of each sound-stream to be streamed from the server using the network communication interface 322 for real-time rendering on a user-designated output device of a client device.

FIG. 4 is a block diagram illustrating the intercommunication between an application server and the plurality of external databases used with a dynamic sound generation system in an embodiment. As illustrated in this embodiment, three different data sources are provided for use with the dynamic sound generation system. The first set of data sources are meta-element databases that store one or more tags in an associative relationship with each of a plurality of geographic locations. In one embodiment, the associative relationship is a lookup table that associates each geographic location to a collection of one or more tags. In addition, specific publicly available database can be used as meta-element database with the dynamic sound generation system. Thus, in one embodiment, the OpenMaps database is used as a meta-element database 312 in this system. In an alternative embodiment, the database maintained by the TIGER service of the US Census Bureau is used as a meta-element database 312. In yet an alternative embodiment, the OpenMaps database and the TIGER service database can be used as two distinct data sources accessible by the application server executing the dynamic sound generation system, or as part of an even larger pool of data sources along with third party data sources which collectively are accessible by the application server. Each database is accessed through an application programming interface called by the Server OS 306 that uses a structured command created by the sound sequencer 308 to assemble the set of sound files including the sound data to be rendered in a sound-stream transmitted to a client device. The structured command used to retrieve tags associated with a search radius of a specified geographic location from the meta-element databases 402 in one embodiment is as follows:
soundTags=soundTagSevice.searchNearLocation(user location, search radius, Type Sound Tags);
   A representative illustration of a record stored in a meta-element database representing the association between location and tag is shown below:

| | |
|---|---|
| Geo Listing: Longitude/Latitude | Tag 1, Tag 2, Tag 3, Tag 4 . . . Tag N |

After one or more tags are identified and retrieved from the meta-element databases 402 in response to a received geographic input, the sound sequencer 308 will generate a second request from the received tags for use in one or more sequential or concurrently executed search and compare operations. The result of these operations produces a listing of addresses where sound files comprised of simulated audio content and synthetic audio content and associated with the matching tags are located in a SoundMaps database 404, in one or more proprietary sound databases 406, or in both types of databases. In one embodiment, at least one of the proprietary sound databases 406 stores custom user-generated sound files that have been tagged for a given geographic location. Representative examples of the content of such custom tagged files include user-created walking tours of neighborhoods at the geographic location, “sonic graffiti” of sound artists, or songs from an interactive musical album tagged to the location. In one embodiment, an option is presented to end-users of a dedicated graphical user interface to access custom user-generated sound files associated with a given geographic location. Message requests received from the graphical user interface for custom user-generated sound files are passed to the application server using an application programming interface for communication with the sound generation resources resident on the application server. In an alternative embodiment, a general purpose graphical user interface is provided to end-users who are presented with one or more options for selecting categories of custom user-generated sound files (e.g., Option 1—Custom Generated Walking Tours of a Geo-Location; Option 2—Artistic Sonic Graffiti, etc.). The structured command used to retrieve sound files from the SoundMaps database for a given location within a search radius in an embodiment is:
soundStreams=soundStreamService.soundStreamsFromLoc(user location, search radius, soundTags);
Other structured commands applicable to one or more proprietary sound databases 406 are generated on demand using an embedded database management service in the sound sequencer 308 in one embodiment. After confirmed matching, the identified sound files are retrieved and assembled into a sound sequence for initial processing by the sound sequencer 308 followed by final processing and sound-stream generation by the sound mixer 310.

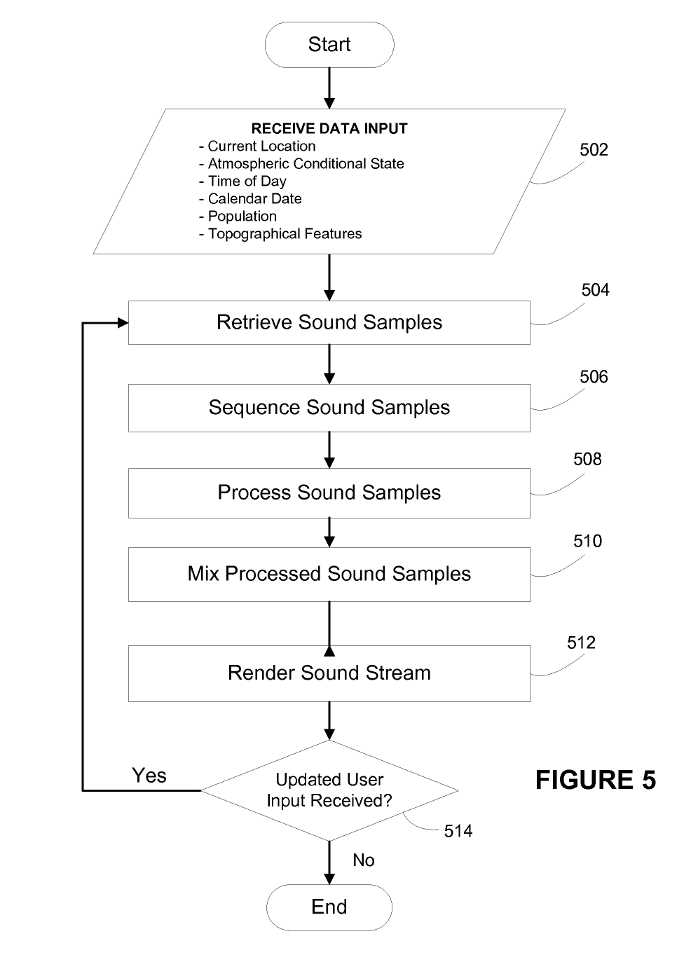

FIG. 5 is an illustration of a method for receiving and processing sound samples in a dynamic sound generation system. In the illustrated embodiment the method commences with a receiving of data input as shown as step 502 where the data input can comprise one or more of the following data items: current location, atmospheric condition state, time, date, population and topographical features. A user interface system is provided to enable end users to submit sound requests from a variety of client devices for processing on an application server. End users can provide custom or user-specific preferences for data input such as atmospheric condition state (i.e., windy, stormy, sunny, etc.), time, date (e.g., historical dates), population size (e.g., desired population size, etc.), and topographical feature. In a preferred embodiment, a current location is determined from a user's GPS geographic coordinates as included in the data input comprising the sound request. The geographic coordinates can be the user's actual geographic location as determined from a GPS sensor in a user's client device or, alternatively, be a specified geographic location as set by an end user. After receiving a user's data input in a sound request, sound samples are retrieved from one or more databases, as shown at step 504. In an embodiment, the sound samples are retrieved from sound files stored in a SoundMap database or in a one or more proprietary databases. In responding to a sound request, an application server receives the user's data input, identifies the GPS geographic coordinates and uses them to search one or more Meta-Element databases to retrieve meta-tags representing the sound attributes or characteristics of the identified geographic location. Afterwards, the meta-tags for the location are read and included in a search request and used in a second search query of the SoundMap database or one or more proprietary sound databases to identify the specific sound files associated with the geographic location. In an embodiment, the stored sound files are in a lossy compression audio format such as MP3 or Ogg Vorbis. In an alternative embodiment, the sound files are stored in a lossless audio format such as Apple Lossless (ALAC), Free Lossless Audio Codec (FLAC), MPEG-4 ALS, or Adaptive Transform Acoustic Coding. Each of the sound files have associated with them certain relational dependencies and behavioral dependencies that are used in a sequencer to determine the optimal ordering of a sound files in a sound stream. In one embodiment, the relational and behavioral dependencies associated with each sound file are comprised of metadata that control (i) rate of playback, (ii) playback sequence, (iii) volume fluctuation, (iv) relational volume settings (e.g., relative attenuation values, etc.). Collectively, the retrieval of sound files from the SoundMap database or other proprietary sound databases produces a “sonic palette” that is a simulated sound environment for a user's given or specified geographic location. The retrieved sound samples (or pointers to them) are then sequenced (as shown at step 506) into an organized form. The sonic palette is the data structure that organizes and stores the relationships between sound files. In one embodiment, the data structure organizes the each sound files according to attenuation level order while also preserving stored associations between each sound file and each file's associated relational dependencies and behavioral dependencies. The ordered attenuation levels and the relational and behavioral dependencies are used for proper rendering of the sound files comprising a sound-stream.

Once sequenced, one or more algorithmic processes are applied to each sound file to adjust the loudness, duration and pitch of sound sample in each sound file in an integrated sound-stream. The processing of sound samples, as shown at step 508, entails the application of one or more algorithms that adjust loudness for each sound file by applying a sound attenuation factor. One or more algorithms are also applied to determine an optimal a stereo pan position for a sound sample in a sonic palette. Once the sound files have been sequenced and associated sound samples processed, a mixing process (as shown at step 510) will be applied that retrieves the sound samples and orders them in the sonic palette according to their sound type using a sound layering process. The sonic palette includes different sound types in the layering process. A first sound type consists of looping sound elements and a second sound type consists of one-shot sound elements. In processing the sound samples, the mixing engine creates a sound-stream comprised of a composite mix of looping sound elements which form the background ambience environment and one-shot sound elements which are randomly distributed within the sonic palette to produce a sound-stream that simulates a sound environment as it does or might exist in the geographic location designed by a user or read from a user's client device. After processing and generation of a sound-stream, the mixing engine will control the transmission of the processed sound-stream to a client device where the received sound-stream will be rendered (as shown at step 512) on one or more of the output devices designated by the end user on the client device. Upon commencement of the rendering of a sound-stream, an active process is initiated to continually monitor for additional user input, as shown at step 514. If updated user input is received, the process will re-commence (as shown at step 514) with a retrieval of sound samples from the sound databases, the sequencing of the sound samples, and the processing and mixing of those sound samples to render a sound-stream on a client device reflecting the updated selections made by a user. If no updated user input is received, the process will continue rendering a sound-stream until a termination request is received at which point the process ends, as shown at step 516.

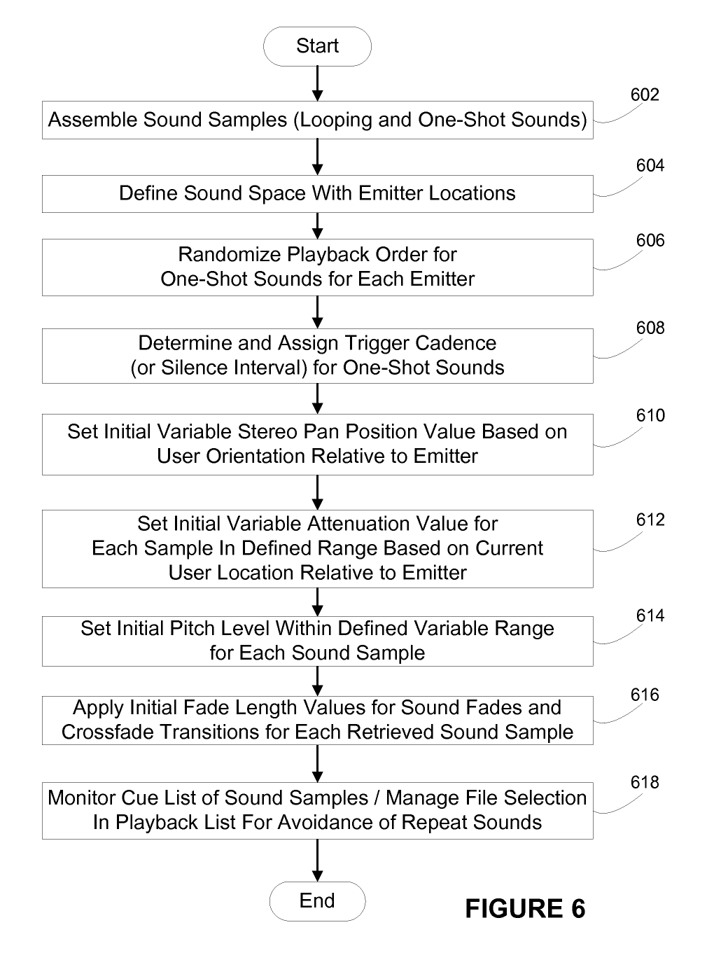

FIG. 6 is an illustration of an embodiment of a method for sequencing sound samples. In the illustrated embodiment, the method begins with the assembling of sound samples which include looping element sounds and one-shot sounds, as shown at step 602. The assembly of sound samples involves the organization of sound files into a continuous sound-stream that is processed and subsequently streamed from an application server for rendering on a local client device. After the assembling of sound samples, a sound space is defined with an initial set of emitter locations determined from a series of tags defining the topographical features of a selected location, as shown at step 604. The emitter locations represent acoustic sound emitters in a physical space defined by location coordinates entered by a user or where an end user (or the user's client device) may be located based on available GPS data. Examples of physical structures serving as emitter locations in a sound space include rivers, buildings, passing trains, trolley cars, rock formations and other natural or man-made objects having certain acoustical properties. As discussed previously, the illustrated embodiment, the sound space is determined from the current location coordinates of a user's client device or a user-selected location The sound-stream is the combination of sounds in sound files having a common set of meta-tags with those tags associated with a geographic location in one or more meta-element databases. After a sound space is defined which establishes the set of looping element sounds to be rendered in the sound-stream for a given geographic location, a randomization process is performed (as shown at step 606) for the one-shot sounds associated with each emitter at a given acoustic location. One-shot sounds include the sounds of birds such as rare or nearly extinct species, extinct animals (as applicable, based on a user's choice of time and date), as well as more familiar sounds such as whirling sound of helicopter blades, the industrial sound sawmills, etc. In addition to the definition of a sound space with looping elements and one-shot sounds, a trigger cadence (or, alternatively a silence interval) for one-shot sounds is determined and assigned to one or more one-shot sounds in the sound-stream. A trigger (or silence interval) can define the rate of occurrence of one-shot sounds in a sound-stream or conversely the duration of silence intervals between one-shot sounds in a sound stream, as shown at step 608. After determining the trigger (or silence interval) and assigning values for frequency of occurrence, initial variable stereo pan position values are set based on the user's orientation relative to emitters in the geographic location, as shown at step 610. A pan position value represents an acoustical placement of a sound within a defined sound space. The strength of the pan position value is determined by a variable having an initial default value that is determined from the relative orientation of the user to a sound emitter. Once the stereo pan position value is determined, an initial value is set for a variable representing the attenuation value for a sound in the sound space, as shown at step 612. In the present embodiment, initial variable attenuation values are set for each sound sample within a defined sound range based on a user's current or user-selected location relative to an emitter. A default value is initially set for the variable attenuation value during the sequencing process. In addition to setting an initial stereo pan position value and an initial variable attenuation value, an initial pitch level is set within a predefined variable range for each sound sample comprising a sound-stream, as shown at step 614. In an embodiment, the variable range defined for the attenuation value extends from +/−3 decibels and the variable range defined the pitch level extend from +/−150 cents. After the establishing such value ranges, the initial fade length values for sound fades and cross fade transitions are applied to each retrieved sound sample in the sound-stream, as shown at step 616. A fade length value represents the duration of an attenuating sound in a sound space for a one-shot sound. A cross fade transition represents the duration of a sound transition from a first sound type to a second sound type. For example, the sound space may initially include the sound of an approaching train or trolley car near the location of an end user. Initially, the sound of the train may initially overtake the sound of a nearby barking dog. However, as the train passes the user's location, the sound of the barking dog is simulated as a constant sound would begin to overtake the sound of the train as the sound of the train acoustically passes farther away from the user's current or specified location. This acoustical phenomena is referred to as a cross fade transition since the sound of the oncoming train initially dominated the sound space but later the fades away as the sound of a nearby barking dog begins to transition into the acoustical forefront. During the sequencing process and the assigning of initial values for variables, a cue list of sound samples is monitored continuously so as to avoid repeat sounds in the sound file selection process during the compilation and creation of a sound-stream. Active monitoring and file management is performed on the playback list of retrieved sound files to increase the unique qualities of a sound-stream for each user, as shown at step 618.

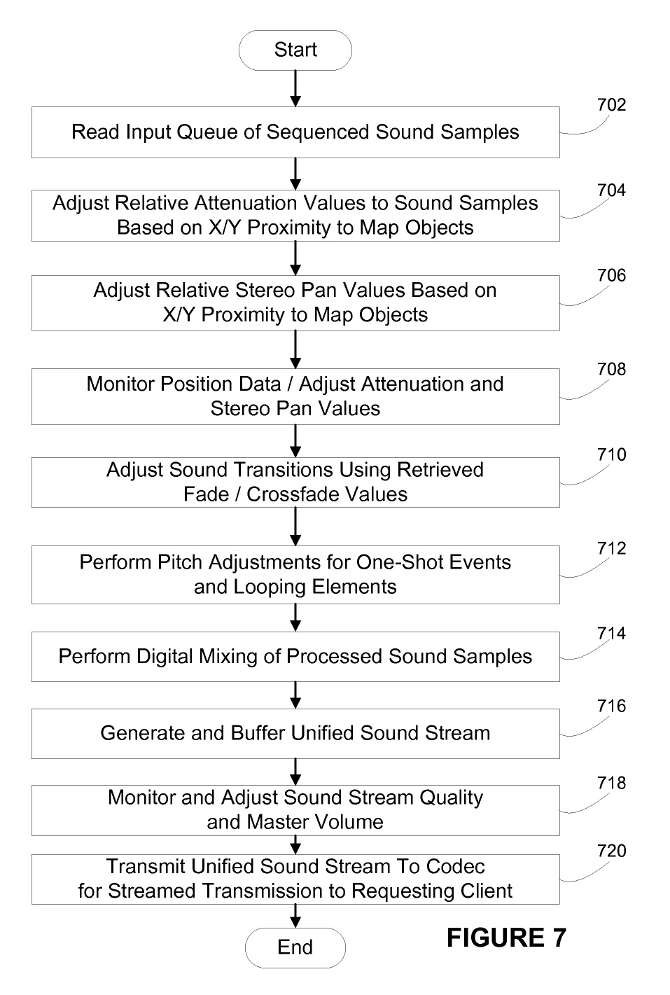

FIG. 7 is an illustration of a method for mixing sequenced sound samples in an embodiment. In the illustrated embodiment, an input queue including sequenced sound samples is read, as shown at step 702. After reading the sequenced sound samples, relative attenuation values for the sound samples are adjusted based on the geographic proximity of a user to specific map objects in a user's physical space as represented by one or more meta-tags associated with the geographic location as stored in one or more meta-element databases and an associated sound map database, as shown at step 704. In addition, relative stereo pan values are adjusted based on the geographic location and proximity of a user to mapped objects (i.e., acoustic emitters) in the user's geographic location, as shows as step 706. The adjusted attenuation values and adjusted stereo pan values result in geographic-specific updates to the initial values set for the variables representing relative attenuation and relative stereo pan position of sounds in a defined sound space. The mixing process continues with the active monitoring of position data (i.e., change of location as determined from updated GPS readings or changes to a user-specified location) and continuous adjustment of attenuation and stereo pan values, as shown at step 708. Active monitoring is a preferred aspect of this process and enables dynamic adjustment of attenuation values and stereo pan values for sounds in a sound space, as shown at step 708. In addition to actively monitoring position data and adjusting attenuation and stereo pan values, sound transitions in the sound space are also adjusted using retrieved fade and cross fade values which are stored in a sound map database or a proprietary database of sounds and associated with stored sound files included in a composite sound stream, as shown at step 710. Continuous pitch adjustments are performed for one-shot sounds and looping elements in the sound space, as shown at step 712, and a layered series of sound files are mixed together to produce a complete ambient sound environment for a given geographic location, as shown at step 714. The digital mixing process of sound samples begins with the compilation of an initial layer of sounds comprising the background or “sonic palette” of a sound space including sounds associated with topographical features, population size, and user-selected date and time. One-shot event sounds are then successively layered into the composite mix of sounds in the sonic palette and are used collectively to create a simulated sound environment such that a user's ear perceives a basic canvas of ambient sounds along with one or more sound samples representing each of a series of one-shot sounds. The combination arising from the digital mixing of processed sound samples generates the sound space that is rendered in a sound-stream when executed on or streamed to a client device. Once generated, the mixed sound-stream is buffered, as shown at step 716. In one embodiment of the mixing engine, the preferred sound-stream transmission rate is a 256 kbps bit-rate for each stereo channel. In this embodiment, eight channels of digital input are provided and two channels for stereo digital output are provided. Real-time parameter controls for each sound channel include attenuation, play, mute, loop, pitch shift and fade/cross fade. A preferred level of sample coding uses 16 bit sound samples and the preferred streaming rate is 44.1 kilohertz for stereo and mono-acoustic sound rendering. The input from the client device is continuously monitored and adjusted to achieve a desired sound stream quality and master volume, as shown at step 718. During the generation of a sound-stream and while it is streamed to a client device for rendering on one or more output devices, active monitoring of the sound-stream quality is performed. This active monitoring enables continual adjustment of the sound-stream to preserve sound quality. Transmission of a sound-stream in one embodiment is accomplished using a codec (coder-decoder) that compresses and encodes the sound-stream using a low loss compression method while monitoring sound-stream quality as streamed transmission of the sound-stream to a client device is performed, as shown at step 720.

Although specific embodiments have been illustrated and described herein, it will be appreciated by those of ordinary skill in the art that a wide variety of alternate and/or equivalent implementations may be substituted for the specific embodiments shown and described without departing from the scope of the present disclosure. This application is intended to cover any adaptations or variations of the embodiments discussed herein.

What I claim is:

1. A method comprising:
receiving a message request;
obtaining a set of geographic coordinates from the received message request;
conducting a first search of one or more meta-element databases using the set of geographic coordinates to obtain a plurality of metatags associated with the set of geographic coordinates;
conducting a second search of one or more audio content databases using the plurality of metatags to obtain a plurality of audio sound files;
generating a sound-stream using the plurality of audio sound files, the audio sound files comprising stored representations of simulated audio content and synthetic audio content associated with the set of geographic coordinates;
encoding the sound-stream for rendering on a client device using one or more device-specific parameters in the message request; and
transmitting the encoded sound-stream to the client device.

2. The method of claim 1 wherein the message request is a service request of a client device that includes at least one field for storing the set of geographic coordinates, a plurality of fields for storing one or more user-specific data inputs and a plurality of fields for storing the one or more device-specific parameters.

3. The method of claim 1 wherein the one or more audio content databases include at least one proprietary sound database for storing custom user-generated audio content.

4. The method of claim 1 wherein the audio sound files are stored in at least one of a lossy compression audio format and a lossless audio format.

5. The method of claim 1 wherein the generating of the sound-stream comprises:
sequencing the audio sound files into a playback list of sound samples, the playback list including one or more looping sounds and one or more one-shot sound events;
applying one or more default values to the playback list of sound samples based on user-specific data inputs, the user-specific data inputs including a setting for atmospheric condition state, a setting for time, a setting for date, a setting for population near the set of geographic coordinates, and a setting for a plurality of topographical features present at the set of geographic coordinates;
defining a sound space based on the playback list of sound samples and the user-specific data inputs based in part on the plurality of topographical features present at the set of geographic coordinates; and
digitally mixing the playback list of sound samples into the sound-stream.

6. The method of claim 5 wherein the one or more default values applied to the playback list of sound samples include a trigger cadence for one-shot sound events, an initial variable stereo pan position value, an initial variable attenuation value, and an initial variable pitch level.

7. The method of claim 5 wherein the digital mixing of the playback list of sound samples comprises adjusting the one or more of the default values.

8. The method of claim 6 wherein the variable attenuation value varies over a range of +/−3 decibels.

9. The method of claim 6 wherein the variable pitch level varies over a range of +/−150 cents.

10. The method of claim 7 wherein the digital mixing of the playback list of sound samples comprises adjusting in real-time the one or more default values applied to the sound samples based on receiving at least one adjusted user-specific data input.

11. The method of claim 1 wherein the transmitting of the encoded sound-stream is performed at 256 kbps on each of two output stereo channels.

12. The method of claim 1 wherein the sound-stream is comprised of 16 bit sound samples.

13. The method of claim 12 wherein the sound samples are rendered on a client device at 44.1 kilohertz for stereo and mono-acoustic sound rendering.

14. The method of claim 1 wherein the device-specific parameters include a decoding rate for a coder/decoder used on a client device.

15. The method of claim 1 wherein the sound-stream is streamed in real-time to the client device after the encoding of the sound-stream.

16. The method of claim 1 wherein the sound-stream is rendered from an application server to a user-designated output device accessed from the client device.

17. The method of claim 1 wherein the set of geographic coordinates are retrieved from a GPS location tracking service used on the client device.

18. A system that generates location-specific sound-streams, the system comprising:
one or more electronic memories;
one or more mass-storage devices;
a processor communicatively coupled to the one or more electronic memories and the one or more mass-storage devices; and
computer instructions stored in one or more of the electronic memories and the mass-storage devices that, when executed by the processor, control the system to:
receive a message request;
obtain a set of geographic coordinates from the received message request;
conduct a first search of one or more meta-element databases using the set of geographic coordinates to obtain a plurality of metatags associated with the set of geographic coordinates;
conduct a second search of one or more audio content databases using the plurality of metatags to obtain a plurality of audio sound files;
generate a sound-stream using the plurality of audio sound files, the audio sound files comprising stored representations of simulated audio content and synthetic audio content associated with the set of geographic coordinates;
encode the sound-stream for rendering on a client device using one or more device-specific parameters in the message request; and
transmit the encoded sound-stream to the client device.

19. The system of claim 18 wherein the message request is a service request of a client device that includes at least one field for storing the set of geographic coordinates, a plurality of fields for storing one or more user-specific data inputs and a plurality of fields for storing the one or more device-specific parameters.

20. The system of claim 18 wherein the one or more audio content databases include at least one proprietary sound database for storing custom user-generated audio content.

21. The system of claim 18 wherein the audio sound files are stored in at least one of a lossy compression audio format and a lossless audio format.

22. The system of claim 18 wherein the sound-stream is generated when the computer instructions further control the system to:
sequence the audio sound files into a playback list of sound samples, the playback list including one or more looping sounds and one or more one-shot sound events;
apply one or more default values to the playback list of sound samples based on user-specific data inputs, the user-specific data inputs including a setting for atmospheric condition state, a setting for time, a setting for date, a setting for population near the set of geographic coordinates, and a setting for a plurality of topographical features present at the set of geographic coordinates;
define a sound space based on the playback list of sound samples and the user-specific data inputs based in part on the plurality of topographical features present at the set of geographic coordinates; and
digitally mix the playback list of sound samples into the sound-stream.

23. The system of claim 22 wherein the one or more default values applied to the playback list of sound samples include a trigger cadence for one-shot sound events, an initial variable stereo pan position value, an initial variable attenuation value, and an initial variable pitch level.

24. The system of claim 22 wherein the digital mixing of the playback list of sound samples comprises adjusting the one or more of the default values.

25. The system of claim 23 wherein the variable attenuation value varies over a range of +/−3 decibels.

26. The system of claim 23 wherein the variable pitch level varies over a range of +/−150 cents.

27. The system of claim 24 wherein the digital mixing of the playback list of sound samples comprises adjusting in real-time the one or more default values applied to the sound samples based on receiving at least one adjusted user-specific data input.

28. The system of claim 18 wherein the encoded sound-stream is transmitted at 256 kbps on each of two output stereo channels.

29. The system of claim 18 wherein the sound-stream is comprised of 16 bit sound samples.

30. The system of claim 29 wherein the sound samples are rendered on a client device at 44.1 kilohertz for stereo and mono-acoustic sound rendering.

31. The system of claim 18 wherein the device-specific parameters include a decoding rate for a coder/decoder used on a client device.

32. The system of claim 18 wherein the sound-stream is streamed in real-time to the client device after the encoding of the sound-stream.

33. The system of claim 18 wherein the sound-stream is rendered from an application server to a user-designated output device accessed from the client device.

34. The system of claim 18 wherein the set of geographic coordinates are retrieved from a GPS location tracking service used on the client device.
